(19) United States
(12) Patent Application Publication
(10) Pub. No.: US 2013/0234415 A1
(43) Pub. Date: Sep. 12, 2013

(54) HYDRAULIC HITCH ASSEMBLY

(71) Applicant: Stuart Alexander Essex, Windang (AU)

(72) Inventor: Stuart Alexander Essex, Windang (AU)

(21) Appl. No.: 13/885,141

(22) PCT Filed: Nov. 11, 2011
(86) PCT No.: PCT/AU11/01457

§ 371 Date: May 13, 2013

(30) Foreign Application Priority Data
Nov. 12, 2010 (AU) 2010905060

(51) Int. Cl. B60D 1/24

(52) U.S. Cl. CPC B60D 1/246
USPC 280/504

(57) ABSTRACT

A hydraulic hitch assembly including oppositely directed jaws operable to releasably grip an attachment including two transverse hinge pins, wherein one of the oppositely directed jaws is fixed relative to the hitch assembly, and the other jaw is moveable between a withdrawn position, in which the oppositely directed jaws can be fitted between the two transverse hinge pins of the attachment, and an extended position, in which the two transverse hinge pins are gripped by the oppositely directed jaws, the hydraulic hitch assembly further including a safety mechanism including an arm moveable between an engaged position and a disengaged position, wherein when the arm is in the engaged position, the arm prevents the transverse hinge pin from being released from the fixed jaw.

The present invention relates a hydraulic hitch assembly which includes a safety mechanism for preventing the unintentional release of an attachment.

### BACKGROUND

Large mobile machinery, such as excavators and the like are commonly being fitted with various types of attachments to increase the versatility of the machine. Examples of such attachments include a bucket or rock hammer. Typically, these attachments are fitted to the articulated arm of the excavator through means of a quick change device such as a hitch assembly, or quick coupler, that is normally hydraulically activated (hereinafter referred to as a hydraulic hitch assembly).

One type of hydraulic hitch assembly is described in Australian patent 586124 and consists of a remotely operated pair of oppositely directed jaws which are adapted to move between an engaged position and a disengaged position. In the disengaged position the jaws can fit between the internal transverse hinge pins of an attachment. The jaws are then moved away from each other through use of a hydraulic piston, or ram, into the engaged position where they grip the transverse hinge pins of the attachment and hold it in place for use.

The present invention seeks to provide a hydraulic hitch assembly including a safety mechanism that prevents the attachment from completely disengaging with the hydraulic hitch assembly even in the event of catastrophic mechanical and/or hydraulic failure.

### SUMMARY

According to one aspect the present invention provides a hydraulic hitch assembly including oppositely directed jaws operable to releasably grip an attachment including two transverse hinge pins, wherein one of the oppositely directed jaws is fixed relative to the hitch assembly, and the other jaw is moveable between a withdrawn position, in which the oppositely directed jaws can be fitted between the two transverse hinge pins of the attachment, and an extended position, in which the two transverse hinge pins are gripped by the oppositely directed jaws, the hydraulic hitch assembly further including a safety mechanism including an arm moveable between an engaged position and a disengaged position, wherein when the arm is in the engaged poSition, the arm prevents the transverse hinge pin from being released from the fixed jaw.

In one form the fixed jaw has an acuate face for receiving a hinge pin of the attachment and the arm of the safety mechanism includes a contact face which is located on an opposing side to the acuate face of the fixed jaw when the arm is in the engaged position.

In one form the arm is moved between the engaged position and the disengaged position by moving about a pivot point. In one form the pivot point is fixed relative to the hydraulic hitch assembly. In one form the pivot point is located at a distal end of the arm from the contact face.

In one form the arm of the safety mechanism is moved between an engaged position and a disengaged position by an actuator positioned on the arm and moveable between an extended position and a retracted position. In one form the arm is in the disengaged position when the actuator is in the extended position. In one form the actuator moves the arm by extending from a retracted position and pushing upon a fixed point relative to the hydraulic hitch assembly. In one form the actuator is a hydraulic cylinder operable by a hydraulic fluid contained within a hydraulic circuit.

In one form the hydraulic hitch assembly includes a hydraulic ram to move the other jaw from a withdrawn position and an extended position and the hydraulic fluid is delivered to the hydraulic cylinder from the hydraulic ram. In one form the hydraulic ram includes a primary cylinder side and a rod side and the hydraulic fluid delivered to the hydraulic cylinder of the safety mechanism is delivered from the rod side of the hydraulic ram.

In one form the safety mechanism includes a mechanical bias to bias the arm towards the engaged position. In one form the mechanical bias is a compression spring. In one form a first end of the compression spring is fixed relative to the hydraulic hitch assembly and a second end of the compression spring is fixed to the arm.

In one form the hydraulic hitch assembly further includes a second safety mechanism, the second safety mechanism including a main body portion which moves between an engaged position, in which the main body portion is aligned to prevent the movement of the other jaw from the extended position to the withdrawn position, and a disengaged position in which the main body portion allows the movement of the other jaw from the extended position to the withdrawn position.

In one form, the second safety mechanism includes a mechanical bias to bias the main body portion to the engaged position and a hydraulic cylinder which when operated, acts against the mechanical bias to move the main body portion to the disengaged position. In one form the hydraulic piston of the second safety mechanism is operable by delivery of hydraulic fluid contained within a hydraulic circuit. In one form the hydraulic fluid is delivered from the rod side of the hydraulic ram of the hydraulic hitch assembly.

In one form the pressure of hydraulic fluid required to operate the hydraulic cylinder of the second safety mechanism to overcome the force of the mechanical bias and move the main body portion to the disengaged position is less than the pressure of the hydraulic fluid required to operate the hydraulic cylinder of the safety mechanism to move the arm to the disengaged position.

According to another aspect the present invention provides a method of releasing an attachment from a hydraulic hitch assembly as herein described the method including the following steps:
a. moving the other jaw of the hydraulic hitch assembly to a withdrawn position;
b. moving the arm of the safety mechanism from an engaged position to a disengaged position; and,
c. releasing the hinge pin of the attachment from the fixed jaw of the hydraulic hitch assembly.

### BRIEF DESCRIPTION OF THE ACCOMPANYING FIGURES

The present invention will become better understood from the following detailed description of various non-limiting embodiments thereof, described in connection with the accompanying figures, wherein:

FIG. 1 is a schematic diagram of a hydraulic hitch assembly including a safety mechanism;

FIG. 2 is a schematic view of a safety mechanism in the engaged position;

FIG. 3 is a schematic view of a safety mechanism in the engaged position;

FIG. 4 is a schematic view of a safety mechanism in the disengaged position; and,

FIG. 5 is a schematic view from above of a safety mechanism;

FIG. 6 is a schematic view of a hydraulic hitch assembly including the safety mechanism in the engaged position and a second safety mechanism in the disengaged position;

FIG. 7 a schematic view of a hydraulic hitch assembly including the safety mechanism in the engaged position and a second safety mechanism in the engaged position;

FIG. 8 is a schematic view of a hydraulic hitch assembly including the safety mechanism in the disengaged position and a second safety mechanism in the disengaged position;

FIG. 9 is a cut away view of the chambers of the hydraulic ram of the hydraulic hitch assembly when the movable jaw is in the extended position;

FIG. 10 is a cut away view of the chambers of the hydraulic ram of the hydraulic hitch assembly when the movable jaw is in the withdrawn position;

FIG. 11a is a schematic view of an articulated arm including a hydraulic hitch assembly in preparation to engage an attachment in the form of a bucket;

FIG. 11b is a schematic view of an articulated arm including a hydraulic hitch assembly engaging an attachment in the form of a bucket;

FIG. 11c is a schematic view of an articulated arm including a hydraulic hitch assembly engaged with an attachment in the form of a bucket; and,

FIG. 11d is a schematic view of an articulated arm including a hydraulic hitch assembly disengaging an attachment in the form of a bucket.

### DETAILED DESCRIPTION OF EMBODIMENTS AND THE ACCOMPANYING FIGURES

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

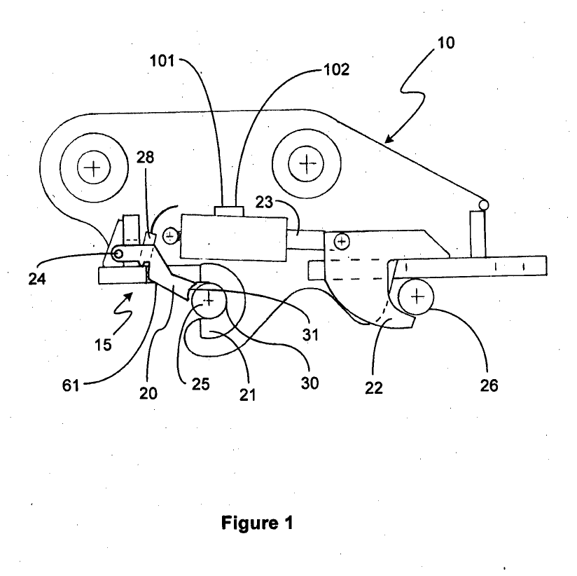

Referring to the accompanying Figures, a hydraulic hitch assembly 10 is depicted in FIG. 1 which is fitted with a safety mechanism 15 in accordance with certain embodiments. The hydraulic hitch assembly includes two oppositely directed jaws 21, 22 which are operable to releasably grip the transverse hinge pins 25, 26 of an attachment. The attachment may be any type of attachment that is commonly attached to heavy machinery using a hydraulic hitch assembly, such as for example a bucket or rock hammer.

The oppositely directed jaws 21, 22 include a fixed jaw 21, which is fixed relative to the body of the hydraulic hitch assembly 10, as well as a moveable jaw 22 that is capable of moving between a withdrawn position in which the two oppositely directed jaws 21, 22 can be fitted between the hinge pins 25, 26 of an attachment, and an extended position (as depicted in FIG. 1) when the oppositely directed jaws are in a position where they grip the hinge pins 25, 26 of the attachment. The moveable jaw 22 moves in a linear fashion relative to the fixed jaw in a slidable arrangement.

The moveable jaw 22 is moved between the withdrawn position and the extended position by a hydraulic ram 23 that is operated by hydraulic fluid contained within a hydraulic circuit which is delivered to the bottom chamber of the hydraulic ram 23 by line 101 and rod side chamber of the hydraulic ram 23 line 102. During typical operation, the hydraulic hitch assembly 10 may be attached to an attachment by fitting the oppositely opposing jaws 21, 22 between the hinge pins 25, 26 of the attachment when the moveable jaw 22 is in the withdrawn position and then moving the moveable jaw 22 into the extended position by operating the hydraulic ram 23 until the oppositely directed jaws 21, 22 grip the transverse hinge pins 25, 26 of the attachment.

The safety mechanism 15 operates with respect to the fixed jaw 21 of the hydraulic hitch assembly 10 and the front transverse hinge pin 25 of the attachment. The safety mechanism 15 includes an arm 20 that is moveable between an engaged position and a disengaged position. FIGS. 1 to 3 each show the arm 20 of the safety mechanism 15 in the engaged position where a contact face 31 of the arm 20 together with the arcuate face 30 of the fixed jaw 21 prevent the transverse hinge pin 25 of the attachment from being released from the hydraulic hitch assembly 10 even when the moveable jaw 22 is in the withdrawn position and the other transverse hinge pin 26 of the attachment is released from the hydraulic hitch assembly 10.

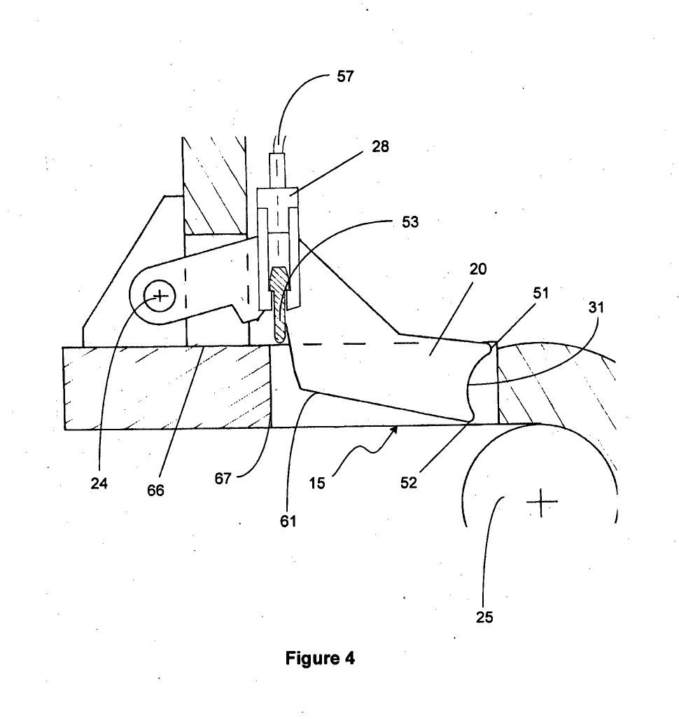

The arm 20 of the safety mechanism 15 is moveable between an engaged position shown in FIGS. 1, 2 and 3 and a disengaged position as shown in FIG. 4 where the contact face 31 of the arm 20 is no longer on the opposing side of the hinge pin 25 to the arcuate face 30 of the fixed jaw 21 such that the hinge pin 25 is able to be released freely from the hydraulic hitch assembly.

The arm 20 of the safety mechanism 15 is able to move between the engaged position and the disengaged position by moving about, or pivoting from, a pivot point 24 which is fixed relative to the hydraulic hitch assembly 10. The pivot point 24 is located at a distal end from the contact face 31 of the arm 20 and is provided by a pin passing through an opening in the body of the arm 20 which is then secured to the body of the hydraulic hitch assembly 10.

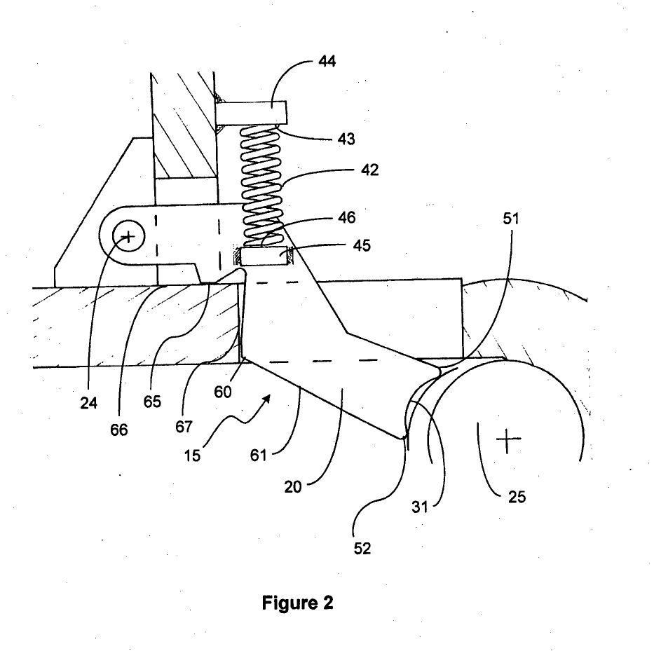

Turning to FIG. 2 there is shown a mechanical bias in the form of a compression spring 42 that is part of the safety mechanism 15. The compression spring 42 acts to bias the arm 20 towards the engaged position shown in FIGS. 1 to 3. The compression spring is fixed at one end 43 to a flange portion of the hydraulic hitch assembly 44 and fixed at the other end 46 to a flange 45 located on the arm 20 of the safety assembly 15. In order to move the arm 20 from the engaged position to the disengaged position the biasing force of the compression spring 42 pushing the arm into the engaged position must be overcome such that the arm 20 may move upwards about the pivot point 24 thereby compressing the body of the compression spring 42 towards the flange 44.

In order to engage a transverse hinge pin 25 onto the fixed jaw 21 of the hydraulic hitch assembly 10, the hinge pin 25 is placed into contact with face 61 of the arm 20 of the safety mechanism 15 whereby the contact force of the hinge pint 25 abutting against face 61 is sufficient to overcome the biasing force of compression spring 42 to move the arm 20 whereby it pivots about the pivot point 24 compresses the compression spring 42 and moves from the engaged position to the disengaged position. The hinge pin 25 is then freely able to move into place and abut the acuate face 30 of jaw 21 at which point there is no longer a force acting on face 61 of the arm 20 of the safety device 15 whereby the biasing force of the compression spring 42 pushes the arm 20 back into the engaged position with the hinge pin 25 safely locked between the contact face 31 and the acuate face 30 of the fixed jaw 21.

The contact face 31 is concave in shape and includes cupping points 52, 51 at either end of the contact face 31. Such a concave shape and cupping points 52, 51 assist in contacting and containing the hinge pin 25 between the arm 20 of the safety assembly 15 and the fixed jaw 21 when the arm 20 is in the engaged position.

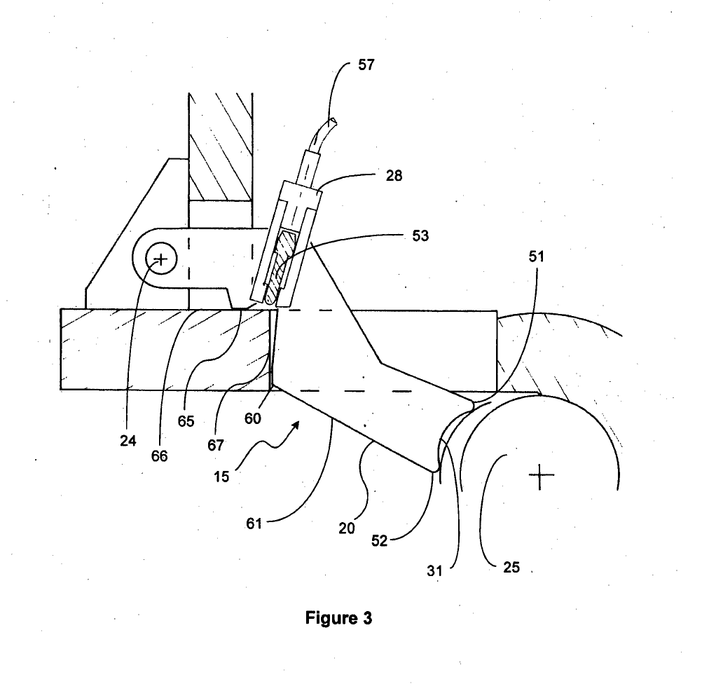

A further structural feature of the design of the safety mechanism 15 is associated with the shape of the arm 20. The arm 20 is itself shaped with in an elbow configuration which provides two points of contact 60, 65 depicted in FIGS. 2 and 3 where the arm 20 is in contact with the main body of the hydraulic hitch assembly 10 when in the engaged position. The first point of contact 65 provides that the arm 20 is in contact with a horizontally aligned flange 66 on the main body of the hydraulic hitch assembly 10 located underneath the pivot point 24. A protrusion extending from the arm and ending in contact point 65 separates the arm from the contact point on the flange 66. This provides that the arm 20 does not rotate further beyond the engaged position around pivot point 24 under the biasing force of the compression spring 42.

The second point of contact 60 is between an outside elbow surface of the arm 20 and a vertically aligned flange 67 located on the main body of the hydraulic hitch assembly. The second contact point 60 provides added structural integrity to the arm 20 such that if the hinge pin 25 is pushed onto the contact face 31 of the arm 20, the full force is not transferred to the pivot point 24 but rather onto the main body of the hydraulic hitch assembly 10.

FIGS. 3 and 4 show an actuator 53 of the safety assembly 15 that is able to be moved from a retracted position shown in FIG. 3 to an extended position shown in FIG. 4. The actuator 53 is moved as part of a hydraulic cylinder 28 that is operated by a hydraulic fluid contained which is delivered via line 57 of a hydraulic circuit. The action of the hydraulic fluid onto the actuator 53 of the hydraulic cylinder 28 forces the actuator 57 into the extended position shown in FIG. 4 where the force of the actuator pushing onto a fixed part of the main body of the hydraulic hitch assembly 10 is sufficient to overcome the biasing force of the compression spring 42 to enable the actuator to move the arm 20 from the engaged position to the disengaged position.

If it is desired to remove the hinge pin 25 of the attachment from the fixed jaw 21 of the hydraulic hitch assembly, then pressure exerted by the hydraulic fluid delivered by the hydraulic circuit 57 onto the hydraulic cylinder 28 forces the actuator 53 to extend onto the fixed point on the main body of the hydraulic hitch assembly 10 pushing the arm 20 to move in a pivotable relation around point 24 and overcoming the biasing force of the compression spring 42 thereby moving contact face 31 from the opposing side of the arcuate face 30 of the fixed jaw 21. The hinge pin 25 of the attachment may then be removed freely from the hydraulic hitch assembly.

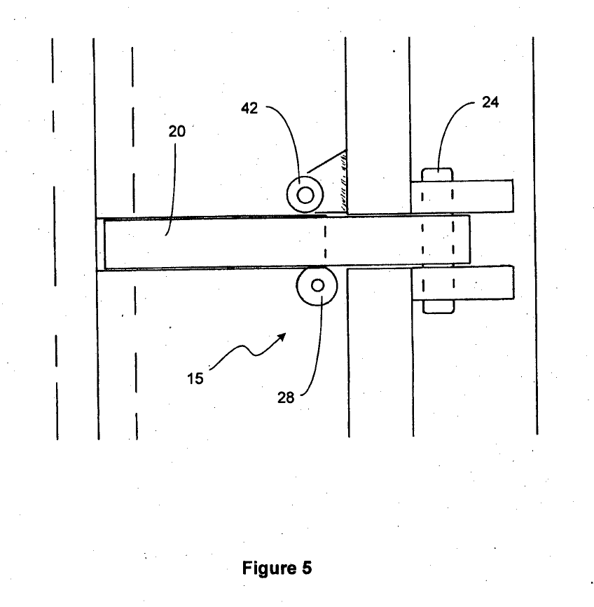

FIG. 5 is an alternate view of the safety assembly 15 showing the arm 20 in relation to the hydraulic cylinder 28 and compression spring 42 and pivoting point 24.

The safety mechanism 15 is able to retain the transverse hinge pin 25 of the attachment at the fixed jaw 21 end of the hydraulic hitch assembly 10 to prevent the disengagement of the attachment from the hydraulic hitch assembly 10 due to catastrophic mechanical and/or hydraulic failure. In such an event, the safety mechanism 15 will retain the transverse hinge pin 25 of the attachment in the front fixed jaw 21 of the hydraulic hitch assembly 10. The attachment may rotate around the retained hinge pin 25 if the moveable jaw 22 of the hydraulic hitch assembly is in the withdrawn position, however, it will not dislodge from the hydraulic hitch assembly 10 altogether.

The safety mechanism 15 also has the added advantage that it is easy to use when engaging an attachment whereby the arm 20 in the engaged position will be moved to the disengaged position when the face of the arm 61 which makes contact with the hinge pin 25 of the attachment is pushed into the disengaged position against the biasing force of the compression spring 42. Once the hinge pin 25 has been placed adjacent the fixed jaw 21 or the arcuate surface 30 of the fixed jaw 21, the arm 20 of the safety assembly 15 will spring back under the mechanical bias of the compression spring 42 into the engaged position.

The safety mechanism 15 may be released by moving the arm 15 into the disengaged position by a single acting hydraulic cylinder 28 which may source its hydraulic fluid from the rod side of the primary hydraulic ram 23 used to push the moveable jaw 22 from the withdrawn to the extended position.

In one form of this embodiment the rod side of the hydraulic ram 23 may be capable of three states of hydraulic pressure. The first is when the pressure is applied to the primary cylinder of the hydraulic ram 23 such that the rod side of the hydraulic ram 23 has theoretically zero pressure. From this state and once pressure is applied to the rod side of the hydraulic ram 23 it will initially have a pilot check valve 128 release pressure which is 1:3 ratios to the captive pressure of the primary cylinder side. Once the check valve 128 release pressure is reached this will activate the pilot check valve 128 which will then release the captive pressure in the primary cylinder of the hydraulic ram 23. The pressure required to release the check valve 128 is also the same hydraulic pressure required to activate the main a hydraulic piston of a second safety mechanism (as described in PCT application PCT/AU2006/001884) to move to the disengaged position before the moveable jaw 22 retracts. Once the primary cylinder side of the hydraulic ram 23 has retracted completely and bottoms out, the rod side goes to an increased or full system pressure. An increased or full system pressure is the preferred pressure required to activate the hydraulic cylinder 28 to act against the compression spring 42 and move the arm 20 of the safety assembly 15 to the disengaged position. In a preferred form, pilot pressure directed to the hydraulic cylinder 28 is insufficient to overcome the biasing of the compression spring and the arm 20 will not move under such conditions and remain in the engaged state preventing the hinge pin 25 from being released from the hitch assembly.

What this means is that when detaching an attachment from a hydraulic hitch assembly 10 the flow of the hydraulic fluid is reversed from the primary cylinder and sent to the rod side of the hydraulic ram 23 at an initial pilot pressure which operates the check valve 128 releasing the pressure on the cylinder side of the hydraulic ram 23. Pilot pressure lifts the main body portion of the second safety mechanism and the moveable jaw 22 then retracts freeing the hinge pin 26 of the moveable jaw.

Once the hydraulic ram 23 has fully retracted the rod side of the hydraulic cylinder then goes to full system pressure. This full system pressure is used to lift the arm 20 of the safety mechanism 15 which provides a sufficient amount of hydraulic pressure to the hydraulic cylinder of the safety mechanism 15 to overcome the biasing force of the compression spring. Once the full system pressure has stopped being applied, even when the hydraulic ram 23 is in the retracted position, the arm 20 of the safety assembly moves to the engaged position under the force of the compression spring.

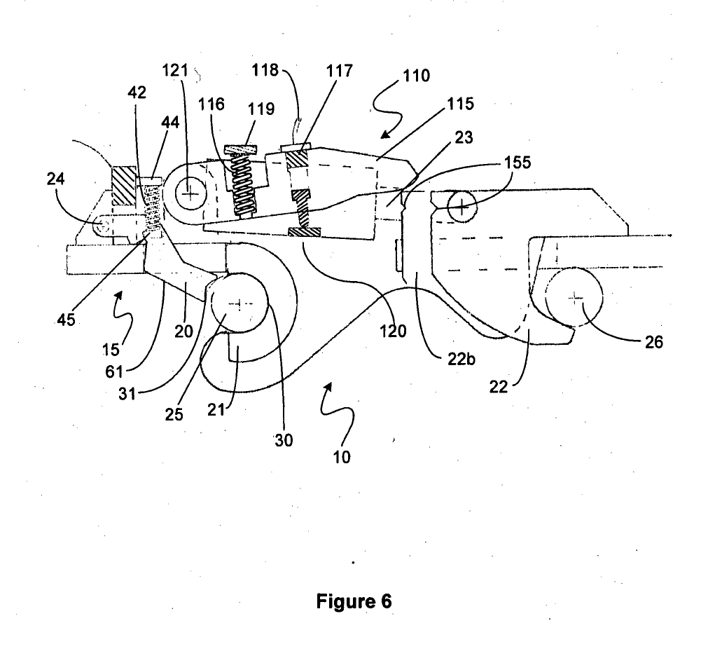

Reference is made to FIGS. 6 to 10 in order to better illustrate the embodiment when the hitch assembly includes the safety mechanism in addition to the second safety mechanism as described in PCT/AU2006/001884.

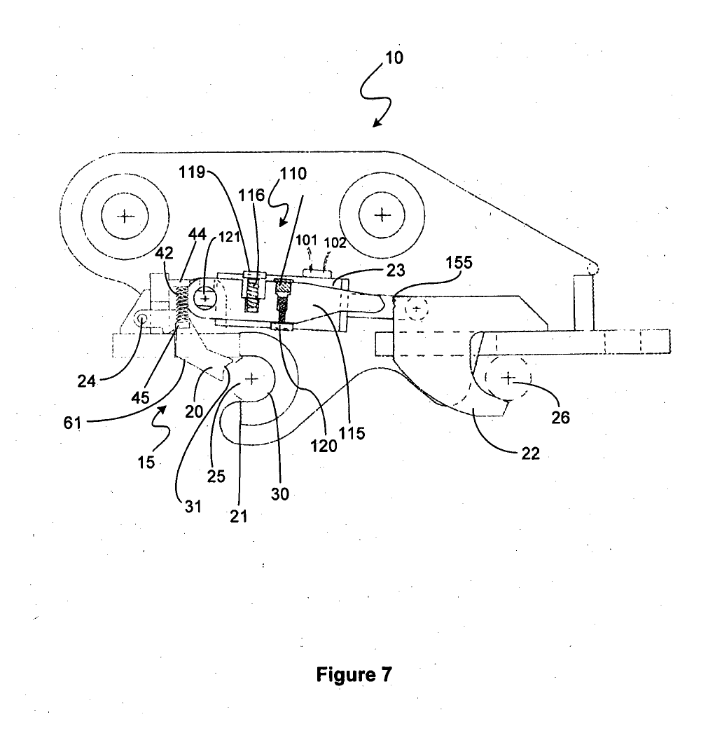

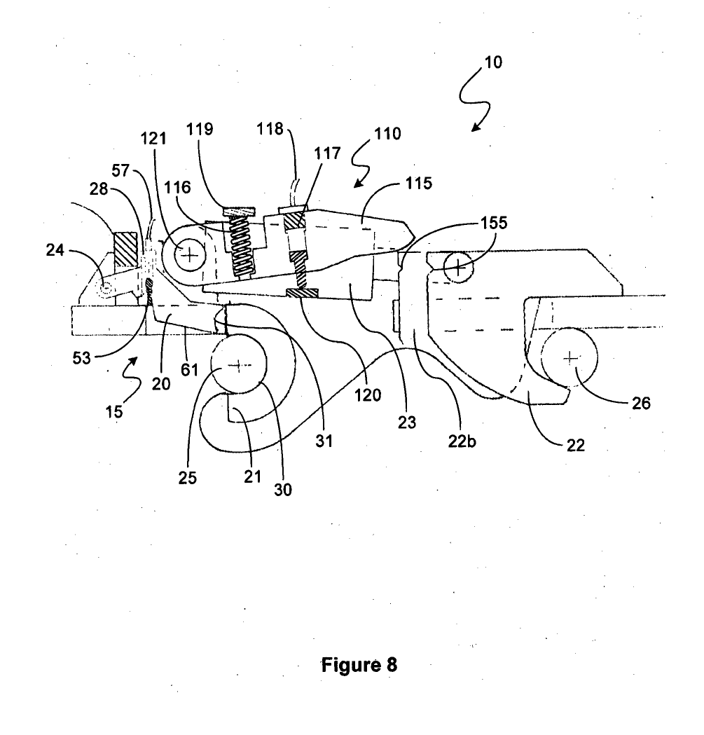

Like numerals have been used in these embodiments to illustrate the various features of the safety mechanism 15 in conjunction with a hitch assembly 10. In addition, a second safety mechanism 110 is depicted which includes a main body portion 115 which is moveable between an engaged position shown in FIG. 7 and a disengaged position shown in FIGS. 6 and 8. In the engaged position shown in FIG. 7 the main body portion 115 prevents the moveable jaw 22 retracting to the withdrawn position by being in alignment with a notch 155 located on the body of the moveable jaw 22 on the side facing the fixed jaw. The main body portion 115 of the second safety mechanism 110 is able to pivot about pivot point 121 which moves the main body portion 115 to the disengaged state shown in FIGS. 6 and 8 wherein the moveable jaw 22 may move to a position 22b which is the withdrawn position allowing the attachment pin 26 to be released from the hitch assembly 10. The second safety mechanism 110 also includes a mechanical bias in the form of a compression spring 116 which acts to bias the main body portion 115 into the engaged position in alignment with the notch 155 located on the moveable jaw 22. A hydraulic cylinder 117 which is operable by means of a hydraulic fluid delivered via line 118 from a hydraulic circuit can be operated to act against the biasing force of a compression spring 116 pushing against a fixed point 120 relative to the hitch assembly 10 and thereby biasing the main body portion 115 to the disengaged position shown in FIGS. 6 and 8.

Referring now to FIGS. 6, 7, 8, 9, 10 and FIGS. 11a to 11d, the various steps associated with attaching an disengaging an attachment including pins 25 and 26 will be described.

Referring to FIGS. 6, 10 and 11a the hitch assembly 10 attached to an articulated arm 200 is lowered with the moveable jaw 22 of the hitch assembly 10 in the withdrawn position wherein the hydraulic ram 23 with primary cylinder 151 and rod side cylinder 150 with theoretically zero hydraulic pressure. With the hydraulic ram 23 in such a state, the arm 20 of the safety mechanism 15 biased into the engaged position under the force of the compression spring 42. The fixed jaw 21 of the hydraulic hitch, assembly is lowered to meet the attachment such that contact surface 61 of the arm 20 meets the attachment pin 25 whereby the attachment pin pushes against contact surface 61 thereby compressing the compression spring 42 which moves arm 20 to the disengaged position allowing the pin 25 to seat within the arcuate face 30 of the fixed jaw 21. In this position, the compression spring moves the arm 20 back into the engaged position once the contact surface 61 is no longer being forced upwards by the attachment pin 25 which provides that attachment pin 25 is now prevented from being released from the fixed jaw 21 by the arm 20 of the safety mechanism 15.

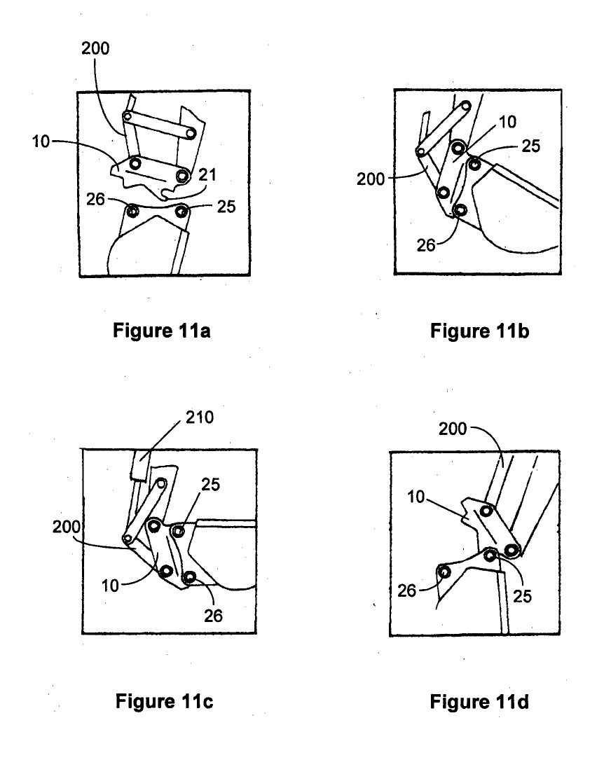

In this point, and referred to FIG. 11b the moveable jaw 22 is in position 22b where the main body portion 115 of the second safety mechanism 115 is in the disengaged position. The articulated arm 200 is then moved such that the hitch assembly 10 is rotated upwards whereby the second pin 26 of the attachment is moved into alignment adjacent the moveable jaw 22. The hydraulic cylinder 210 that rotates the articulated arm 200 to this position includes a non-rod side which will be in excess of 3,000 psi when fully bottomed out. By means of a directional control valve this high pressure may be diverted to port 101 of the hydraulic ram 23 of the hitch assembly 10. This high hydraulic pressure moves the hydraulic ram 23 thereby moving the moveable jaw 22 into the extended position which thereby allows the main body portion 115 of the second safety mechanism 110 to move into the engaged position where it is an alignment with a notch 155 located on the moveable jaw. The hinge pins of the attachment are now fully attached to the hitch assembly 10 and the pressure located in the primary side of the hydraulic ram 23 is shut off by means of the check valve 128 to maintain the hinge pins of the attachment locked in place to the hydraulic hitch assembly 10 for use. This state is depicted with reference to FIGS. 7, 9 and 11c.

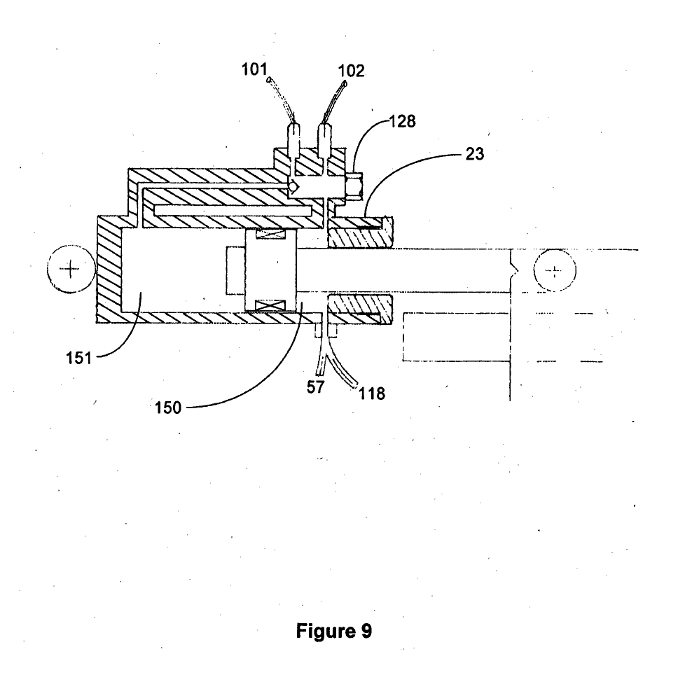

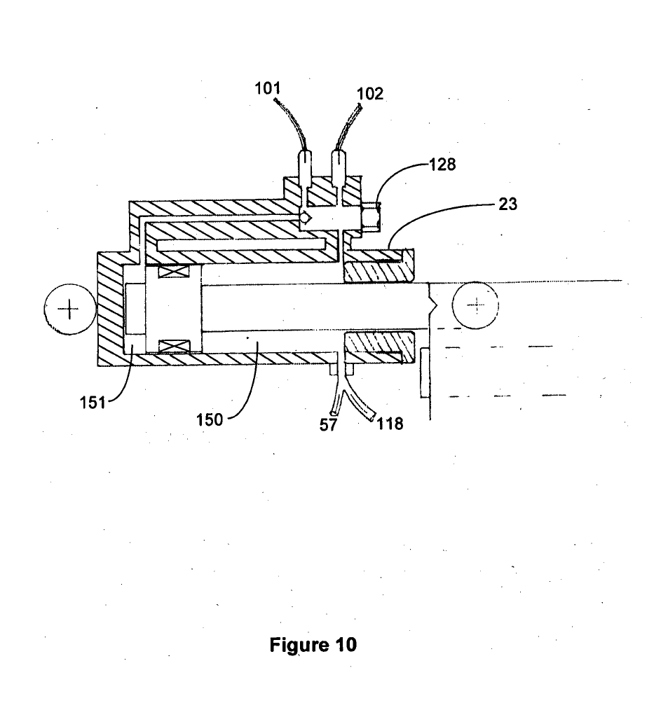

With reference to FIGS. 9 and 10 the check valve 128 has a 3:1 release pressure ratio in this embodiment which means that if the captured hydraulic pressure is 3,000 psi in the primary cylinder 151 the check valve 128 release pressure will be 1,000 psi. 1,000 psi is referred to herein as a low pressure.

In the event that there is a hydraulic failure, the second safety mechanism 115 will remain in the engaged position thereby preventing the moveable jaw 22 from retracting thereby maintaining the attachment hinge pins within the moveable jaws.

Furthermore, if there is a further mechanical failure the fixed jaw maintains its grip around the hinge pin 25 as the arm 20 of the safety mechanism prevents release of the hinge pin.

In order to release the hinge pins of the attachment from the hitch assembly 10, an initial reversal of hydraulic pressure is diverted to port 102 by bottoming out the main hydraulic cylinder of the articulated arm 200. The hydraulic pressure directed to port 102 into the rod side of the hydraulic ram 23 is then also directed through ports 118 and 57 which lead to the hydraulic cylinder 117 of the second safety device and the hydraulic cylinder 28 of the safety mechanism 15.

The first initial low pressure pilot check valve 128 release pressure of up to 1,000 psi in this embodiment is sufficient to operate hydraulic cylinder 117 to overcome the biasing force compression spring 116 thereby moving the main body 115 of the second safety mechanism 110 to the disengaged portion. However, the pilot check valve 128 release pressure, or low pressure of up to 1,000 psi is insufficient to operate hydraulic cylinder 28 in order to overcome the biasing force of spring 42 in order to move the arm 20 of the safety mechanism 15 to the disengaged position to allow the release of hinge pin 25 from the fixed jaw 21 of the hitch assembly 10. This state can be seen depicted in FIG. 11d.

Once the check valve 128 pressure of 1,000 psi has been reached and the main body portion 115 of the second safety mechanism 110 has been moved to the disengaged position the moveable jaw 22 retracts as the pressure in chamber 150 then goes to high pressure of 3,000 psi which is delivered via port 57 to hydraulic cylinder 28 thereby providing a force sufficient to overcome the biasing force of the compression spring 42 which lifts the arm 20 of the safety mechanism 15 allowing the release of the hinge pin 31 from the fixed jaw 21 of the hitch assembly 10. The attachment may then be removed entirely from the hydraulic hitch assembly.

Many modifications will be apparent to those skilled in the art without departing from the scope of the present invention.

1. A hydraulic hitch assembly including oppositely directed jaws operable to releasably grip an attachment including two transverse hinge pins, wherein one of the oppositely directed jaws is fixed relative to the hitch assembly, and the other jaw is moveable between a withdrawn position, in which the oppositely directed jaws can be fitted between the two transverse hinge pins of the attachment, and an extended position, in which the two transverse hinge pins are gripped by the oppositely directed jaws, the hydraulic hitch assembly further including a hydraulic ram which moves the other jaw between the withdrawn position and the extended position, and a safety mechanism including an arm moveable between an engaged position and a disengaged position by a hydraulic cylinder positioned on the arm and operable by a hydraulic fluid that is delivered to the hydraulic cylinder from the hydraulic ram, wherein when the arm is in the engaged position, the transverse hinge pin is contained between the arm and the fixed jaw which thereby prevents the transverse hinge pin from being released from the fixed jaw.

2. A hydraulic hitch assembly according to claim 1 wherein the fixed jaw has an arcuate face for receiving a hinge pin of the attachment and the arm of the safety mechanism includes a contact face which is located on an opposing side to the arcuate face of the fixed jaw when the arm is in the engaged position.

3. A hydraulic hitch assembly according to claim 1 wherein the arm is moved between the engaged position and the disengaged position by moving about a pivot point.

4. A hydraulic hitch assembly according to claim 3 wherein the pivot point is fixed relative to the hydraulic hitch assembly.

5. A hydraulic hitch assembly according to claim 3 wherein the pivot point is located at a distal end of the arm from the contact face.

6. A hydraulic hitch assembly according to claim 3 wherein the pivot point is located on the hitch assembly on an opposing side to the arcuate face of the fixed jaw.

7. A hydraulic hitch assembly according to claim 1 wherein the hydraulic cylinder is moveable between an extended position and a retracted position.

8. A hydraulic hitch assembly according to claim 7 wherein the arm is in the disengaged position when the hydraulic cylinder is in the extended position.

9. A hydraulic hitch assembly according to claim 8 wherein the hydraulic cylinder moves the arm by extending from the retracted position and pushing upon a fixed point relative to the hydraulic hitch assembly.

10. A hydraulic hitch assembly according to claim 9 wherein the hydraulic cylinder is operable by a hydraulic fluid contained within a hydraulic circuit.

11. A hydraulic hitch assembly according to claim 1 wherein the hydraulic ram includes a primary cylinder side and a rod side and the hydraulic fluid delivered to the hydraulic cylinder of the safety mechanism is delivered from the rod side of the hydraulic ram.

12. A hydraulic hitch assembly according to claim 1 wherein the safety mechanism includes a mechanical bias to bias the arm towards the engaged position.

13. A hydraulic hitch assembly according to claim 12 wherein the mechanical bias is a compression spring.

14. A hydraulic hitch assembly according to claim 13 wherein a first end of the compression spring is fixed relative to the hydraulic hitch assembly and a second end of the compression spring is fixed to the arm.

15. A hydraulic hitch assembly according to claim 12 wherein the arm includes a further face which is contacted by the transverse hinge pin when engaging the transverse hinge pin with the fixed jaw.

16. A hydraulic hitch assembly according to claim 15 whereby when engaging the transverse hinge pin with the fixed jaw the transverse hinge pin first contacts the further face of the arm which moves the arm into the disengaged position to allow the transverse hinge pin to abut against the arcuate face of the fixed jaw.

17. A hydraulic hitch assembly according to claim 16 wherein once the transverse hinge pin is abutting against the fixed jaw the mechanical bias acts to move the arm into the engaged position.

18. A hydraulic hitch assembly according to claim 1 wherein the hydraulic hitch assembly further includes a second safety mechanism the second safety mechanism including a main body portion which moves between an engaged position, in which the main body portion is aligned to prevent the movement of the other jaw from the extended position to the withdrawn position, and a disengaged position in which the main body portion allows the movement of the other jaw from the extended position to the withdrawn position.

19. A attachment from hydraulic hitch assembly according to claim 18
wherein the second safety mechanism includes a mechanical bias to bias the main body portion to the engaged position and a hydraulic cylinder which when operated, acts against the mechanical bias to move the main body portion to the disengaged position.

20. A hydraulic hitch assembly according to claim 19 wherein the hydraulic cylinder of the second safety mechanism is operable by delivery of hydraulic fluid contained within a hydraulic circuit and wherein the hydraulic fluid is delivered from the rod side of the hydraulic ram of the hydraulic hitch assembly.

21. A hydraulic hitch assembly according to claim 20 wherein the pressure of hydraulic fluid required to operate the hydraulic cylinder of the second safety mechanism to overcome the force of the mechanical bias and move the main body portion to the disengaged position is less than the pressure of the hydraulic fluid required to operate the hydraulic cylinder of the safety mechanism to move the arm to the disengaged position.

22. A method of releasing an attachment from a hydraulic hitch assembly according claim 1, the method including the following steps:
a. moving the other jaw of the hydraulic hitch assembly to a withdrawn position;
b. moving the arm of the safety mechanism from an engaged position to a disengaged position; and,
c. releasing the hinge pin of the attachment from the fixed jaw of the hydraulic hitch assembly.
